(19) United States
(12) Patent Application Publication
(10) Pub. No.: US 2007/0173274 A1
(43) Pub. Date: Jul. 26, 2007

(54) Power control method for a reverse data service

(76) Inventor: Chae Bong Lim, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/555,905

(22) PCT Filed: May 28, 2004
(86) PCT No.: PCT/KR04/01273

§ 371 Date: Nov. 21, 2006

(30) Foreign Application Priority Data
May 29, 2003 (KR) 10-2003-0034434

(51) Int. Cl. H04B 7/00; H04Q 7/20

(52) U.S. Cl. 455/522

(57) ABSTRACT

An external circuit power control method for a reverse data service is provided. The system efficiency can be improved in a reverse data service at 144 Kbps by adopting an optimized reverse channel external circuit power control algorithm. The power control method of the present invention applies a new outer loop external circuit power control algorithm in order to improve performance of the reverse data service at 144 Kpbs. The algorithm determines a Target Eb/Nt according to the frame state of a supplemental channel through which data is transmitted. That is, the power control method of the present invention applies the frame state of the data inputted to the supplemental channel as an important value in determining power control, whereas in the conventional algorithm, a voice rate and frame state received through a reverse fundamental channel are considered in determining power control. Therefore, the present invention can reduce the complexity of the conventional algorithm and perform the outer loop power control correctly according to the state of real input data.

### TECHNICAL FIELD

The present invention relates to an external circuit power control method for a reverse data service. The system efficiency can be improved in a reverse data service at 144 Kbps by adopting an optiminzed outer loop external circuit power control algorithm. The power control method of the present invention applies a new outer loop circuit power control algorithm in order to improve the performance of the reverse data service at 144 Kbps. The algorithm determines a Target Eb/Nt according to the frame state of a supplemental channel through which data is transmitted. That is, the power control method of the present invention applies the frame state of the data inputted to the supplemental channel as an important value in determining power control, whereas in the conventional algorithm, a voice rate and frame state received through a reverse fundamental channel are considered in determining power control. Therefore, the present invention can reduce the complexity of the conventional algorithm and perform the outer loop power control correctly according to the state of real input data.

### BACKGROUND ART

In general, an outer loop power control method is used to maintain frame error rate (FER) of =b 1=l % by controlling the signal power of a traffic channel transmitted from a mobile station (MS) to a base transceiver station (BTS).

In other words, a frame error can occur because of data loss which may be caused due to channel environment, although the signal intensity received through the BTS satisfies a reference threshold. To control this, the BTS increases the reference threshold by a predetermined level when the frame state is poor and reduces the reference threshold by a predetermined level when the frame state is good. That is, the outer loop power control method is to control the power of the MS by changing the reference threshold.

Meanwhile, the outer loop power control method is an optimized algorithm to advance the voice quality and performs the external circuit power control by using a reverse fundamental channel.

However, the outer loop power control method mainly performs the power control to full and half rate, which is generally important at voice. Therefore, a reverse supplemental channel is farther used in addition to the reverse fundamental channel in case the reverse data service is implemented rather than the voice service. Further, data at 144Kbps, which is important in the data service, is transmitted through the reverse supplemental channel.

Therefore, the channel through which the data is transmitted from the MS to the BTS is the reverse supplemental channel. However, the frame error such as data loss, which can occur in the supplemental channel, cannot be reflected. This is because the value of the Target Eb/Nt reflects only a frame state of the reverse fundamental channel.

### DISCLOSURE OF THE INVENTION

The object of the present invention is to provide an external circuit power control method for a reverse data service. Such method applies the frame state of the data inputted to the supplemental channel as an important value in determining power control, whereas in the conventional algorithm, a voice rate and frame state received through a reverse fundamental channel are considered in determining power control. Therefore, the present invention can reduce the complexity of the conventional algorithm and perform the outer loop power control correctly according to the state of real input data.

To accomplish the above-mentioned object, an external circuit power control method for a reverse data service comprises the following steps:

if an input frame is determined to be normal and the number of continuous Good Frames (full_rate_cnt) exceeds a critical value (Threshold2), decreasing a value of a Target Eb/Nt by a first predetermined level (pwrctl_down);

if the input frame is determined to be normal and the number of continuous Bad Frames (bad_frame_cnt) exceeds a critical value (Threshold1), increasing the value of the Target Eb/Nt by a second predetermined level (pwrctl_full_up), and if not, increasing the value by a third predetermined level (pwrctl_little_up); and

if there is no input frame and the number of continuous Null Frames (null_rate_cnt) exceeds a critical value (Threshold3), increasing the value of the Target Eb/Nt by a fourth predetermined level (pwrctl_null_up).

### BRIEF DESCRIPTION OF DRAWING

FIG. 1 is a flow chart illustrating an external circuit power control process for a reverse data service.

### BEST MODE FOR CARRYING OUT THE INVENTION

The embodiment of the present invention will be described with reference to the accompanying drawings according to the above-identified technical scope of the present invention.

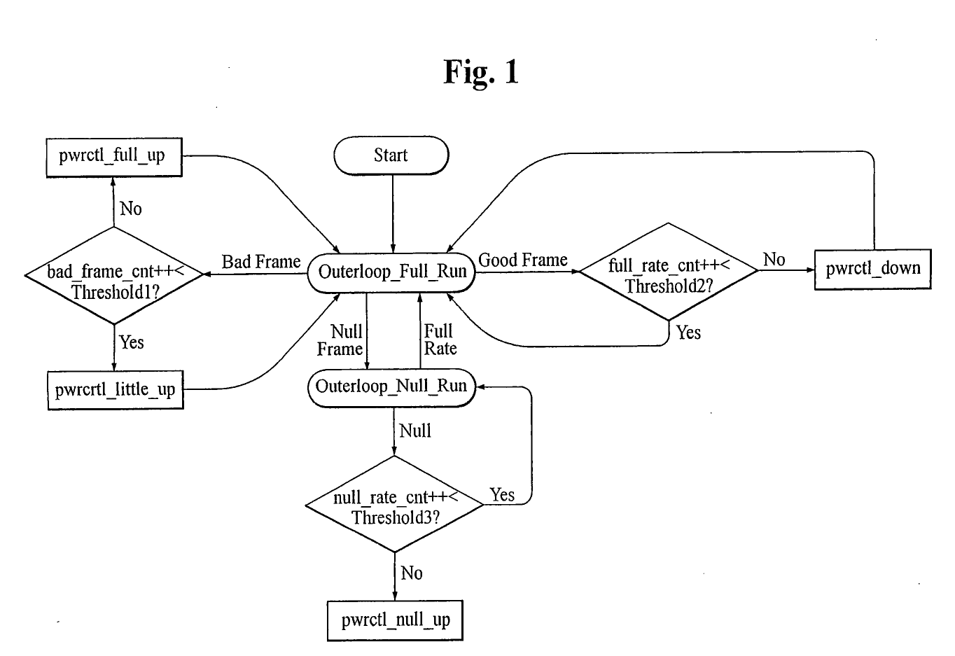

FIG. 1 is a flow chart illustrating an external circuit power control process for a reverse data service.

As shown, the process comprises the steps of: if an input frame is determined to be normal and the number of continuous Good Frames (full_rate_cnt) exceeds a critical value (Threshold2), decreasing a value of a Target Eb/Nt by a first predetermined level (pwrctl_down); if the input frame is determined to be normal and the number of continuous Bad Frames (bad_frame_cnt) exceeds a critical value (Threshold1), increasing the value of the Target Eb/Nt by a second predetermined level (pwrctl_full_up), and if not, increasing the value by a third predetermined level (pwrctl_little_up); and if there is no input frame and the number of continuous Null Frames (null_rate_cnt) exceeds a critical value (Threshold3), increasing the value of the Target Eb/Nt by a fourth predetermined level (pwrctl_null_up).

The process as described above will now be discussed in more detail.

First, the present invention is largely divided into an Outerloop_Full_Run State and an Outerloop_Null_Run State according to a frame transmission state of data as shown in FIG. 1.

The Outerloop_Full_Run State decreases a value of a Target Eb/Nt by a first predetermined level (pwrctl_down) if an input frame is determined to be normal and the number of continuous Good Frames (full_rate_cnt) exceeds a critical Threshold2. Further, the Outerloop_Full_Run State increases the value of the Target Eb/Nt by a second predetermined level (pwrctl_fall_up) if the input frame is determined to be normal and the number of continuous Bad Frames (bad_frame_cnt) exceeds a critical Threshold1. If not, then increasing the value by a third predetermined level (pwrctl_little_up).

Next, the Outerloop_Null_Run State increases the value of the Target Eb/Nt by a fourth predetermined level (pwrctl_null_up) if there is no input frame and the number of continuous Null Frames (null_rate_cnt) exceeds a critical Threshold3.

This is to check a channel state by gradually increasing the power of a mobile terminal. This is because there is no correct data whether the null frame is inputted by a problem associated with channel environment or by an absence of data to be transmitted from the mobile station.

Meanwhile, the values of Threshold1, Threshold2 and Threshold3 used above must be selected after performing a parameter optimizing operation. They do not change the value of the Target Eb/Nt until receiving the predetermined number of frames after increasing or decreasing the previous Target Eb/Nt.

Further, the values of pwrctl_down, pwrctl_full up, pwrctl_little_up and pwrctl_null_up applied to the algorithm must be determined by the parameter optimizing operation.

While the present invention has been shown and described with respect to the particular external circuit power control method for a reverse data service, it will be apparent to those skilled in the art that many changes and modifications may be made without departing from the scope of the invention as defined in the appended claims and those equivalent thereto.

### INDUSTRIAL APPLICABILITY

According to the present invention, the power control method of the present invention applies the frame state of the data inputted to the supplemental channel as an important value in determining a power control, whereas in the conventional algorithm, a voice rate and frame state received through a reverse fundamental channel are considered in determining power control. Therefore, the present invention can reduce the complexity of the conventional algorithm and perform the outer loop power control correctly according to the state of real input data.

Further, the present invention can improve the data process capability and receive stably at the poor wireless channel environment by using a data-centered outer loop external circuit power control algorithm rather than a voice-centered outer loop external circuit power control algorithm.

Further, the present invention can reflect whether the frame of the supplemental channel through which the data is transmitted is normal or not.

1. An external circuit power control method for a reverse data service, comprising the steps of:
if an input frame is determined to be normal and the number of continuous Good Frames (full_rate_cnt) exceeds a critical value (Threshold2), decreasing a value of a Target Eb/Nt by a first predetermined level (pwrctl_down);
if the input frame is determined to be normal and the number of continuous Bad Frames (bad_frame_cnt) exceeds a critical value (Threshold), increasing the value of the Target Eb/Nt by a second predetermined level (pwrctl_full_up), and if not, increasing the value by a third predetermined level (pwrctl_little_up); and
if there is no input frame and the number of continuous Null Frames (null_rate_cnt) exceeds a critical value (Threshold3), increasing the value of the Target Eb/Nt by a fourth predetermined level (pwrctl_null_up).

2. The method of claim 1, wherein the values of Threshold1, Threshold2 and Threshold3 are selected after performing a parameter optimizing operation, the values being adopted to change the value of the Target Eb/Nt after the previous Target Eb/Nt is increased or decreased and the predetermined number of frames is received.
